(19) United States
(12) Patent Application Publication
(10) Pub. No.: US 2024/0107628 A1
(43) Pub. Date: Mar. 28, 2024

(54) METHOD, DEVICE AND COMPUTER PROGRAM PRODUCT FOR WIRELESS COMMUNICATION

(71) Applicant: ZTE CORPORATION, Shenzhen (CN)

(72) Inventors: Wei MA, Shenzhen (CN); Hongjun LIU, Shenzhen (CN); Boshan ZHANG, Shenzhen (CN); Wu WEN, Shenzhen (CN); Dongmei LI, Shenzhen (CN); Zijiang MA, Shenzhen (CN); Chen LU, Shenzhen (CN)

(73) Assignee: ZTE CORPORATION, Shenzhen (CN)

(21) Appl. No.: 18/481,881

(22) Filed: Oct. 5, 2023

Related U.S. Application Data
(63) Continuation of application No. PCT/CN2021/086056, filed on Apr. 9, 2021.

(51) Int. Cl. H04W 76/30

(52) U.S. Cl. CPC H04W 76/30

(57) ABSTRACT

Method, device and computer program product for wireless communication are provided. A method includes: receiving, by a wireless communication terminal, a first release message; and releasing, by the wireless communication terminal, at least one small data transmission, SDT, configuration stored in the wireless communication terminal according to a cell where the first release message is received or according to information of SDT configuration carried by the first release message.

### CROSS-REFERENCE TO RELATED PATENT APPLICATIONS

This application is a Continuation of PCT/CN2021/086056, filed Apr. 9, 2021, incorporated herein by reference in its entirety.

### TECHNICAL FIELD

This document is directed generally to wireless communications.

### BACKGROUND

In New Radio (NR) of 5G communication, UEs (user equipments) can enter an RRC_INACTIVE state/mode to reduce power consumption. Typically, in the RRC_INACTIVE state, a UE cannot transmit data. Thus, the UE has to resume connections (i.e., switches back to the RRC_CONNECTED state) for the downlink (e.g., mobile termination (MT)) and uplink (e.g., mobile originated (MO)) data. However, for small and infrequent data transmission, building up and releasing connections each time when the transmission is needed is inefficient and power consuming.

### SUMMARY

In order to solve this problem, a gNodeB (gNB) may provide a Small Data Transmission (SDT) configuration to a UE to allow the UE to perform small data transmission (also referred to as SDT transmission) in the RRC_INACTIVE state according to the SDT configuration. However, the conditions for storing and releasing the SDT configuration are still unclear.

The present disclosure relates to methods, devices, and computer program products for wireless communication, which can allow a UE to store and release SDT configuration(s).

One aspect of the present disclosure relates to a wireless communication method. In an embodiment, the wireless communication method includes: receiving, by a wireless communication terminal, a first release message; and releasing, by the wireless communication terminal, at least one small data transmission, SDT, configuration stored in the wireless communication terminal according to a cell where the first release message is received or according to information of SDT configuration carried by the first release message.

Another aspect of the present disclosure relates to a wireless communication method. In an embodiment, the wireless communication method includes transmitting, by a wireless communication node, a first release message to a wireless communication terminal to instruct the wireless communication terminal releasing at least one small data transmission, SDT, configuration according to a first cell where the first release message is received by the wireless communication terminal or according to information of SDT configuration carried by the first release message.

Another aspect of the present disclosure relates to a wireless communication terminal. In an embodiment, the wireless communication terminal includes a communication unit and a processor. The processor is configured to receive a first release message; and release at least one small data transmission, SDT, configuration stored in the wireless communication terminal according to a cell where the first release message is received or according to information of SDT configuration carried by the first release message.

Another aspect of the present disclosure relates to a wireless communication node. In an embodiment, the wireless communication node includes a communication unit and a processor. The processor is configured to transmit a first release message to a wireless communication terminal to instruct the wireless communication terminal releasing at least one small data transmission, SDT, configuration according to a first cell where the first release message is received by the wireless communication terminal or according to information of SDT configuration carried by the first release message.

Various embodiments may preferably implement the following features:

Preferably or in some embodiments, the at least one SDT configuration is transmitted to the wireless communication terminal via a second release message, and the wireless communication terminal is configured to release all of the at least one SDT configuration stored in the wireless communication terminal in response to the first release message and the second release message are received via different cells.

Preferably or in some embodiments, the wireless communication terminal is configured to release all of the at least one SDT configuration stored in the wireless communication terminal in response to the first release message comprising at least one update SDT configuration.

Preferably or in some embodiments, the wireless communication terminal is configured to store at least one update SDT configuration in response to the first release message comprising the at least one update SDT configuration.

Preferably or in some embodiments, the wireless communication terminal is configured to release all of the at least one SDT configuration stored in the wireless communication terminal in response to the first release message comprising a release indicator.

Preferably or in some embodiments, the first release message comprises a release list, and the wireless communication terminal is configured to release at least a portion of the at least one SDT configuration according to the release list.

Preferably or in some embodiments, the wireless communication terminal is configured to release at least one timer for the at least one SDT configuration according to the first release message.

Preferably or in some embodiments, the first release message is a radio resource control, RRC, release message.

Preferably or in some embodiments, the wireless communication terminal is configured to release the at least one SDT configuration in response to the first release message comprising a release indicator or a release list and not comprising any update SDT configuration.

Preferably or in some embodiments, the at least one SDT configuration is transmitted to the wireless communication terminal via a second release message, the wireless communication terminal is configured to release the at least one SDT configuration in response to the first release message and the second release message being received via different cells and the first release message not comprising a release indicator or a release list and any update SDT configuration.

Preferably or in some embodiments, the at least one SDT configuration is transmitted to the wireless communication terminal via a second release message, the wireless communication terminal is configured to release the at least one SDT configuration in response to the first release message comprising a release indicator or a release list and the first release message and the second release message being received in an identical cell.

Preferably or in some embodiments, the at least one SDT configuration is transmitted to the wireless communication terminal via a second release message, the wireless communication terminal is configured to release the at least one SDT configuration in response to the first release message comprising at least one update SDT configuration, the first release message not comprising any release indicator or any release list, and the first release message and the second release message being received in an identical cell.

Preferably or in some embodiments, the at least one SDT configuration is transmitted to the wireless communication terminal via a second release message in a second cell, and the wireless communication node is configured to transmit the first release message in the first cell different from the second cell to instruct the wireless communication terminal releasing all of the at least one SDT configuration.

Preferably or in some embodiments, the wireless communication node is configured to transmit the first release message comprising at least one update SDT configuration to instruct the wireless communication terminal releasing all of the at least one SDT configuration.

Preferably or in some embodiments, the wireless communication node is configured to transmit the first release message comprising at least one update SDT configuration to instruct the wireless communication terminal storing the at least one update SDT configuration.

Preferably or in some embodiments, the wireless communication node is configured to transmit the first release message comprising a release indicator to instruct the wireless communication terminal releasing all of the at least one SDT configuration.

Preferably or in some embodiments, the wireless communication node is configured to transmit the first release message comprising a release list to instruct the wireless communication terminal releasing at least a portion of the at least one SDT configuration according to the release list.

Preferably or in some embodiments, the wireless communication node is configured to transmit the first release message to instruct the wireless communication terminal releasing at least one timer for the at least one SDT configuration.

Preferably or in some embodiments, the first release message is a radio resource control, RRC, release message.

The present disclosure relates to a computer program product including a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### DESCRIPTION OF THE DRAWINGS

FIG. 1 shows a schematic diagram of storing and releasing one or more SDT-Configs according to an embodiment of the present disclosure.

FIG. 2 shows another schematic diagram of storing and releasing one or more SDT-Configs according to an embodiment of the present disclosure.

FIG. 3 shows another schematic diagram of storing and releasing one or more SDT-Configs according to an embodiment of the present disclosure.

FIG. 4 shows an example of a schematic diagram of a wireless communication terminal according to an embodiment of the present disclosure.

FIG. 5 shows an example of a schematic diagram of another wireless communication node according to another embodiment of the present disclosure.

FIG. 6 shows a flowchart of a wireless communication method according to an embodiment of the present disclosure.

FIG. 7 shows a flowchart of another wireless communication method according to an embodiment of the present disclosure.

### DETAILED DESCRIPTION

Some terms used in this disclosure are specified below.

SDT: small data transmission or specific data transmission

SDT resource: SDT resource may be one of below resources: pre-configured UL resource (PUR), configured-grant (CG) resource, or any other pre-configured resource.

SDT configuration: SDT configuration may include at least one of: at least one SDT resource; at least one SDT index; at least one SDT duration or SDT timer; or at least one SDT indicator.

### Embodiment 1: UE Receives RRCRelease Message in New Cell

According to an embodiment of the present disclosure, a UE may store one or more SDT configurations (also referred to as SDT-Configs in below) from a gNB. When the UE receives an RRCRelease message from the same gNB or another gNB, the UE may check whether the current cell (i.e., the cell receiving the RRCRelease message) is different from the cell where the SDT-Configs are provided to the UE. For example, if the SDT-Configs currently stored by the UE is provided to the UE via a certain cell CO, the UE may check whether the RRCRelease message is received via the same cell CO. If the SDT-Configs stored by the UE and the RRCRelease message are received via different cells, the UE may discard and/or release the stored SDT-Configs. Otherwise, the UE may keep storing the SDT-Configs.

In an embodiment, when receiving the SDT-Configs, the UE may store the information of the cell (e.g., the cell ID) where the UE receives the SDT-Configs. In an embodiment, when the UE receives the RRCRelease message, the UE may determine whether the cell where the UE receives the SDT-Configs is identical to the cell where the UE receives the RRCRelease message according to the stored information of the cell. In an embodiment, the UE may determine whether the stored cell ID corresponding to receiving of the SDT-Configs is identical to the cell ID of the cell where the UE receives the RRCRelease message.

In an embodiment, the UE stores multiple SDT-Configs provided via an old cell, and when the UE receives the RRCRelease message via a new cell different from the old cell where the UE receives the SDT-Configs, the UE may discard and/or release all of the SDT-Configs provided via the old cell.

In an embodiment, the UE may discard and/or release one or more timer (also referred to as SDT-config timer hereinafter) corresponding to the SDT-Configs in response to the SDT-Configs stored by the UE and the RRCRelease message being received via different cells.

In an embodiment, from the perspective of the gNB, the gNB may send the RRCRelease message to the UE in a new cell, to notify the UE to discard and/or release the SDT-Configs received from the old cell.

### Embodiment 2: UE Receives RRCRelease Message Including New SDT-Config(s)

According to an embodiment of the present disclosure, a UE may store one or more SDT-Configs. When the UE receives an RRCRelease message including one or more new SDT-Configs (also referred to as update SDT-Configs), the UE may release and/or discard the stored SDT-Configs.

In an embodiment, when one or more timers for the one or more stored SDT-Configs are configured, the UE may discard and/or release the one or more timers for the one or more stored SDT-Configs.

In an embodiment, the UE may store and/or configure the new one or more SDT-Configs after receiving the RRCRelease message. In an embodiment, if one or more new SDT-config timers for the one or more new SDT-Config is included in the RRCRelease message, the UE may also store and run the one or more new SDT-config timers.

In an embodiment, before an SDT-config timer is expired, the UE can use an SDT-Config corresponding to this timer for SDT. After the SDT-config timer is expired, the UE may discard the SDT-Config and stop using the SDT-Config. One SDT-config timer can be configured for one or more SDT-Configs. If each SDT-Config(s) corresponds to a unique SDT-config timer, the UE may decide to use one or more available SDT resources and not to use one or more unavailable SDT resources according to whether each SDT-config timer is expired or not.

In an embodiment, from the perspective of the gNB, the gNB may send the RRCRelease message including the SDT-Configs to the UE, to notify the UE to setup the SDT-Configs, and release and/or discard the one or more previously stored SDT-Configs.

### Embodiment 3: UE Receives RRCRelease Message Including IE (Information Element) to Indicate UE Releasing SDT-Config(s)

According to an embodiment of the present disclosure, a UE may store one or more SDT-Configs. When the UE receives an RRCRelease message including an IE to indicate that the SDT-Configs should be released, the UE may release and/or discard all the stored SDT-Configs or one or more specific SDT-Configs according to the RRCRelease message.

In an embodiment, if the IE is for a specific SDT-Config or specific multiple SDT-Configs, the UE will release the specific SDT-Config or the specific multiple SDT-Configs.

In an embodiment, to indicate to release a specific SDT-Config or multiple SDT-Configs, the IE may include information of a specific SDT-Config or specific multiple SDT-Configs, such as an SDT-Config ID or a list of SDT-Config ID. In an embodiment, the IE may include a list including one or more IDs of SDT-Configs to be released.

In an embodiment, the IE may include an indicator to notify the UE to release all of the stored SDT-Configs.

In an embodiment, from the perspective of the gNB, the gNB may send the RRCRelease message including a specific SDT-Config or specific multiple SDT-Configs, such as an SDT-Config ID or a list of SDT-Config ID, to notify the UE to release and/or discard the specific one or more SDT-Configs.

In an embodiment, the gNB may send the RRCRelease message including an indicator to notify the UE to release all of the stored SDT-Configs.

### Embodiment 4

According to an embodiment of the present disclosure, a UE may store one or more SDT-Configs. When the UE receives an RRCRelease message from a gNB, the UE may perform the following operations, in particular in the following order:
(1) The UE checks whether the RRCRelease message includes one or more new SDT-Configs to be set up. If so, the UE may store the one or more new SDT-Configs, and/or release all of the one or more stored SDT-Configs.

Details of this operation can be ascertained by referring to Embodiment 2 described above and will not be repeated herein.
(2) If the RRCRelease message does not include one or more new SDT-Configs to be set up, the UE checks whether the RRCRelease message includes information instructing a specific SDT-Config or specific multiple SDT-Configs to be released, or an indicator instructing all SDT-config to be released. If so, the UE may release the specific SDT-Config, the specific multiple SDT-Configs, or all the stored SDT-Configs.

Details of this operation can be ascertained by referring to Embodiment 3 described above and will not be repeated herein.
(3) If the RRCRelease message does not include said information or indicator in the operation (2), the UE checks whether the current cell where the RRCRelease message is received is the same as the cell where the stored SDT-Configs is received. If not, the UE releases the one or more stored SDT-Configs.

Details of this operation can be ascertained by referring to Embodiment 1 described above and will not be repeated herein.

### Embodiment 5

According to an embodiment of the present disclosure, a UE may store one or more SDT-Configs. When the UE receives an RRCRelease message from a gNB, the UE may perform the following operations, in particular in the following order:
(1) The UE checks whether the current cell where the RRCRelease message is received is the same as the cell where the stored SDT-Configs is received. If not, the UE releases the one or more stored SDT-Configs.

Details of this operation can be ascertained by referring to Embodiment 1 described above and will not be repeated herein.
(2) If the current cell where the RRCRelease message is received is the same as the cell where the stored SDT-Configs is received, the UE checks whether the RRCRelease message includes information instructing a specific SDT-Config or specific multiple SDT-Configs to be released, or an indicator instructing all SDT-config to be released. If so, the UE may release the specific SDT-Config, the specific multiple SDT-Configs, or all the stored SDT-Config s.

Details of this operation can be ascertained by referring to Embodiment 3 described above and will not be repeated herein.
(3) If the RRCRelease message does not include said information or indicator in the operation (2), the UE checks whether the RRCRelease message includes one or more new SDT-Configs to be set up. If so, the UE may store the one or more new SDT-Configs, and/or release all of the one or more stored SDT-Configs.

Details of this operation can be ascertained by referring to Embodiment 3 described above and will not be repeated herein.

Note that, Embodiments 4 and 5 are merely for illustrative purposes, and the present disclosure is not limited to the order in Embodiments 4 and 5 described above.

### Embodiment 6: Procedure 1 for SDT-Config(s) Storing and Releasing

According to an embodiment of the present disclosure, an example procedure for storing and releasing one or more SDT-Configs is provided below.

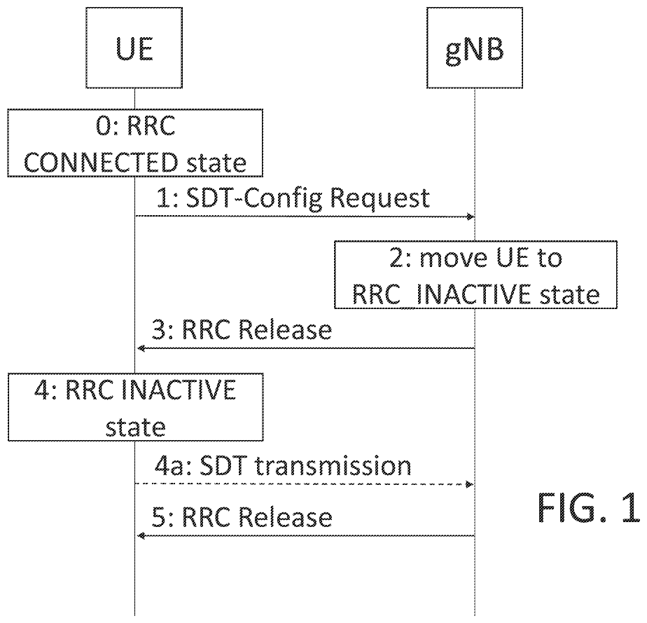

FIG. 1 shows a schematic diagram of storing and releasing one or more SDT-Configs according to an embodiment of the present disclosure.

In Operation 0, the UE is in the RRC_CONNECTED mode, and both the UE and its camping cell support SDT-config function. In an embodiment, the CG (configured-grant) solution is enabled in the camping cell of the UE.

In Operation 1, the UE may inform the gNB that the UE would like to be configured with the SDT (e.g., PUR) by sending an RRC message (e.g., CG ConfigurationRequest message). In an embodiment, the RRC message may include an SDT-config request information about the requested resource (e.g., No. of occurrences, periodicity, time offset, TBS (Transport Block Size), RRC Ack, etc.).

In Operation 2, the gNB decides to move the UE to the RRC_INACTIVE mode.

In Operation 3, the gNB sends an RRCRelease message to the UE. In an embodiment, the gNB occupies the SDT resource (e.g., CG resource) for this UE, so that the UE can use the occupied SDT resource after the UE enters the RRC_INACTIVE state. In an embodiment, the RRCRelease message includes an SDT-Config (e.g., information of the SDT resource, such as a CG resource configuration). In an embodiment, the RRCRelease message includes a suspend indicator.

In Operation 4, the UE enters the RRC_INACTIVE state and stores the SDT-Config.

In Operation 4a, the UE may perform one or more SDT transmission according to the SDT-Config received in Operation 3. In an embodiment, Operation 4a may be omitted.

In Operation 5, the gNB sends another RRCRelease message to the UE with a specific IE to instruct the UE releasing a specific SDT-Config or all SDT-Configs stored by the UE. Details of Operation 5 can be ascertained by referring to Embodiment 3, and will not be repeated herein.

In addition, if the RRCRelease message in Operation 5 includes one or more new SDT-Configs to be set up, the UE may store the one or more new SDT-Config.

### Embodiment 7: Procedure 2 for SDT-Config(s) Storing and Releasing

According to an embodiment of the present disclosure, an example procedure for storing and releasing one or more SDT-Configs is provided below.

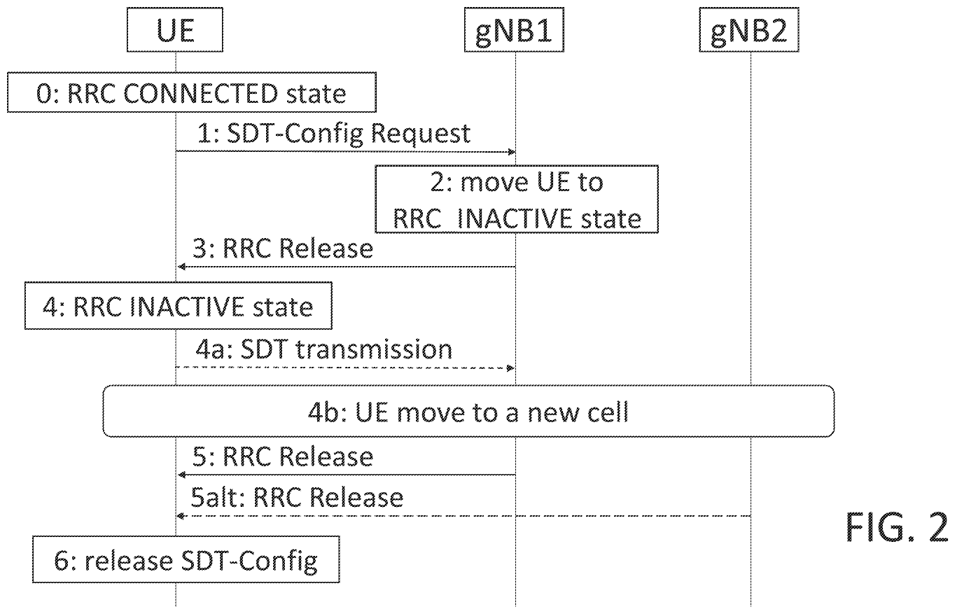

FIG. 2 shows another schematic diagram of storing and releasing one or more SDT-Configs according to an embodiment of the present disclosure.

In Operation 0, the UE is in the RRC_CONNECTED mode, and both the UE and its camping cell support SDT-config function. In an embodiment, the CG (configured-grant) solution is enabled in the camping cell of the UE.

In Operation 1, the UE may inform the gNB1 that the UE would like to be configured with the SDT (e.g., PUR) by sending an RRC message (e.g., CG ConfigurationRequest message). In an embodiment, the RRC message may include an SDT-config request information about the requested resource (e.g., No. of occurrences, periodicity, time offset, TBS (Transport Block Size), RRC Ack, etc.).

In Operation 2, the gNB1 decides to move the UE to the RRC_INACTIVE mode.

In Operation 3, the gNB sends an RRCRelease message to the UE. In an embodiment, the gNB occupies the SDT resource (e.g., CG resource) for this UE, so that the UE can use the occupied SDT resource after the UE enters the RRC_INACTIVE state. In an embodiment, the RRCRelease message includes an SDT-Config (e.g., information of the SDT resource, such as a CG resource configuration). In an embodiment, the RRCRelease message includes a suspend indicator.

In Operation 4, the UE enters the RRC_INACTIVE state and stores the SDT-Config.

In Operation 4a, the UE may perform one or more SDT transmission according to the SDT-Config received in Operation 3. In an embodiment, Operation 4a may be omitted.

In Operation 4b, the UE moves to a new cell, by cell reselection, by handover, or by cell selection. In an embodiment, the new cell may be a cell served by the gNB1 or a gNB2 different from the gNB1.

In Operation 5, if the new cell is a cell served by the gNB1, the gNB1 sends another RRCRelease message (e.g., a second RRCRelease message) to the UE.

In Operation Salt, alternatively, if the new cell is a cell served by the gNB2, the gNB2 sends another RRCRelease message (e.g., a second RRCRelease message) to the UE.

In Operation 6, the UE determines that the first RRCRelease message and the second RRCRelease message are received via different cell, and accordingly release the stored SDT-Config.

Details of Operation 6 can be ascertained by referring to Embodiment 1, and will not be repeated herein.

In addition, if the RRCRelease message in Operation 5 or Salt includes one or more new SDT-Configs to be set up, the UE may store the one or more new SDT-Config.

### Embodiment 8: Procedure 3 for SDT-Config(s) Storing and Releasing

According to an embodiment of the present disclosure, an example procedure for storing and releasing one or more SDT-Configs is provided below.

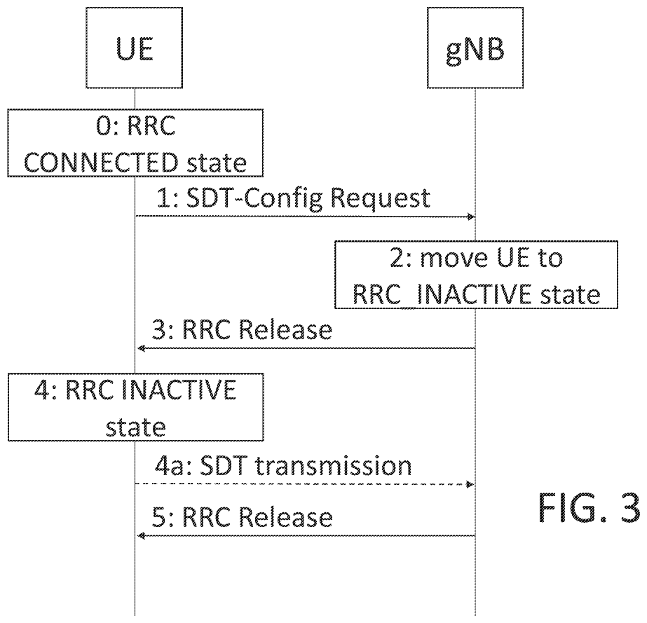

FIG. 3 shows a schematic diagram of storing and releasing one or more SDT-Configs according to an embodiment of the present disclosure.

In Operation 0, the UE is in the RRC_CONNECTED mode, and both the UE and its camping cell support SDT-config function. In an embodiment, the CG (configured-grant) solution is enabled in the camping cell of the UE.

In Operation 1, the UE may inform the gNB that the UE would like to be configured with the SDT (e.g., PUR) by sending an RRC message (e.g., CG ConfigurationRequest message). In an embodiment, the RRC message may include an SDT-config request information about the requested resource (e.g., No. of occurrences, periodicity, time offset, TBS (Transport Block Size), RRC Ack, etc.).

In Operation 2, the gNB decides to move the UE to the RRC_INACTIVE mode.

In Operation 3, the gNB sends an RRCRelease message to the UE. In an embodiment, the gNB occupies the SDT resource (e.g., CG resource) for this UE, so that the UE can use the occupied SDT resource after the UE enters the RRC_INACTIVE state. In an embodiment, the RRCRelease message includes an SDT-Config (e.g., information of the SDT resource, such as a CG resource configuration). In an embodiment, the RRCRelease message includes a suspend indicator.

In Operation 4, the UE enters the RRC_INACTIVE state and stores the SDT-Config.

In Operation 4a, the UE may perform one or more SDT transmission according to the SDT-Config received in Operation 3. In an embodiment, Operation 4a may be omitted.

In Operation 5, the gNB sends another RRCRelease message to the UE with one or more new SDT-Config to make or instruct the UE to store the one or more new SDT-Config and/or release the SDT-Config previously stored (i.e., the SDT-Config stored in Operation 4). Details of Operation 5 can be ascertained by referring to Embodiment 2, and will not be repeated herein.

According to an embodiment of the present disclosure, a UE may receive an RRCRerelease message. If the cell where the UE receives RRCRerelease message is not same as the cell where one or more SDT-Configs are provided to the UE, the UE may release and/or discard the stored SDT-Config(s). Besides, the UE may release one or more timers for the SDT-Config s.

According to an embodiment of the present disclosure, if the RRCRerelease message includes one or more new SDT-Configs, the UE may release and/or discard the one or more previously stored SDT-Configs. If one or more timers for the previously stored SDT-Configs are configured, the UE may release the timers for the previously stored SDT-Configs.

According to an embodiment of the present disclosure, if an IE in the RRCRerelease message indicating that the SDT-Configs should be released, the UE may release and/or discard all the stored SDT-Configs or one or more specific SDT-Configs.

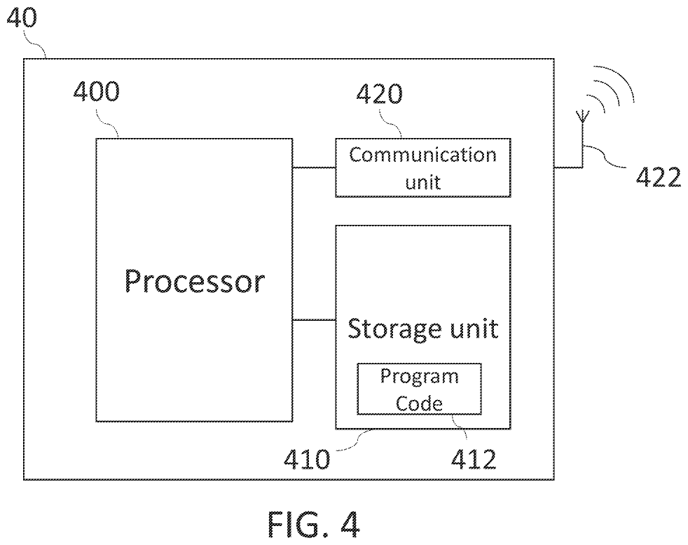

FIG. 4 relates to a schematic diagram of a wireless communication terminal 40 (e.g., a terminal node or a terminal device) according to an embodiment of the present disclosure. The wireless communication terminal 40 may be a user equipment (UE), a mobile phone, a laptop, a tablet computer, an electronic book or a portable computer system and is not limited herein. The wireless communication terminal 40 may include a processor 400 such as a microprocessor or Application Specific Integrated Circuit (ASIC), a storage unit 410 and a communication unit 420. The storage unit 410 may be any data storage device that stores a program code 412, which is accessed and executed by the processor 400. Embodiments of the storage code 412 include but are not limited to a subscriber identity module (SIM), read-only memory (ROM), flash memory, random-access memory (RAM), hard-disk, and optical data storage device. The communication unit 420 may a transceiver and is used to transmit and receive signals (e.g., messages or packets) according to processing results of the processor 400. In an embodiment, the communication unit 420 transmits and receives the signals via at least one antenna 422.

In an embodiment, the storage unit 410 and the program code 412 may be omitted and the processor 400 may include a storage unit with stored program code.

The processor 400 may implement any one of the steps in exemplified embodiments on the wireless communication terminal 40, e.g., by executing the program code 412.

The communication unit 420 may be a transceiver. The communication unit 420 may as an alternative or in addition be combining a transmitting unit and a receiving unit configured to transmit and to receive, respectively, signals to and from a wireless communication node.

In some embodiments, the wireless communication terminal 40 may be used to perform the operations of the UE described above. In some embodiments, the processor 400 and the communication unit 420 collaboratively perform the operations described above. For example, the processor 400 performs operations and transmit or receive signals, message, and/or information through the communication unit 420.

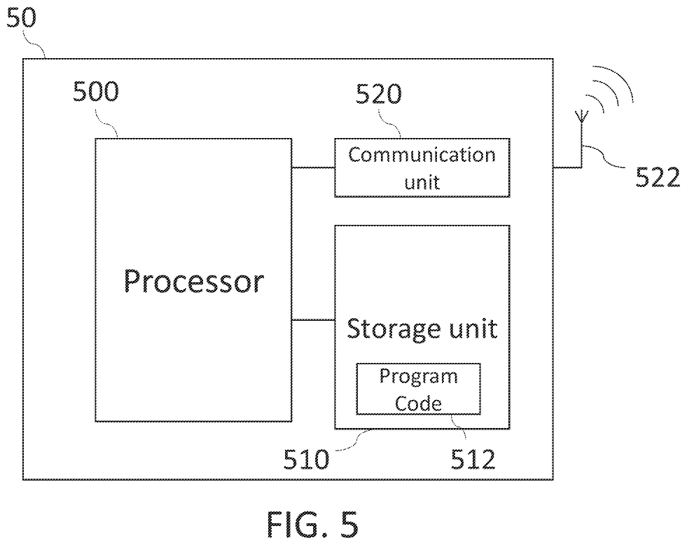

FIG. 5 relates to a schematic diagram of a wireless communication node 50 (e.g., a network device) according to an embodiment of the present disclosure. The wireless communication node 50 may be a satellite, a base station (BS) (e.g., a gNB), a network entity, a Mobility Management Entity (MME), Serving Gateway (S-GW), Packet Data Network (PDN) Gateway (P-GW), a radio access network (RAN), a next generation RAN (NG-RAN), a data network, a core network or a Radio Network Controller (RNC), and is not limited herein. In addition, the wireless communication node 50 may include (perform) at least one network function such as an access and mobility management function (AMF), a session management function (SMF), a user place function (UPF), a policy control function (PCF), an application function (AF), etc. The wireless communication node 50 may include a processor 500 such as a microprocessor or ASIC, a storage unit 510 and a communication unit 520. The storage unit 510 may be any data storage device that stores a program code 512, which is accessed and executed by the processor 500. Examples of the storage unit 512 include but are not limited to a SIM, ROM, flash memory, RAM, hard-disk, and optical data storage device. The communication unit 520 may be a transceiver and is used to transmit and receive signals (E.g., messages or packets) according to processing results of the processor 500. In an example, the communication unit 520 transmits and receives the signals via at least one antenna 522.

In an embodiment, the storage unit 510 and the program code 512 may be omitted. The processor 500 may include a storage unit with stored program code.

The processor 500 may implement any steps described in exemplified embodiments on the wireless communication node 50, e.g., via executing the program code 512.

The communication unit 520 may be a transceiver. The communication unit 520 may as an alternative or in addition be combining a transmitting unit and a receiving unit configured to transmit and to receive, respectively, signals, messages, or information to and from a wireless terminal (E.g., a user equipment).

In some embodiments, the wireless communication node 50 may be used to perform the operations of the gNB described above. In some embodiments, the processor 500 and the communication unit 520 collaboratively perform the operations described above. For example, the processor 500 performs operations and transmit or receive signals through the communication unit 520.

A wireless communication method is also provided according to an embodiment of the present disclosure. In an embodiment, the wireless communication method may be performed by using a wireless communication terminal (e.g., a UE). In an embodiment, the wireless communication terminal may be implemented by using the wireless communication terminal 40 described above, but is not limited thereto.

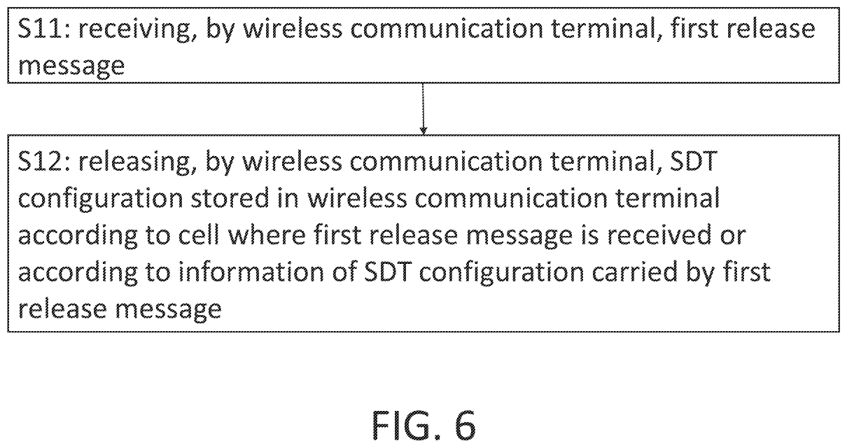

Referring to FIG. 6, in an embodiment, the wireless communication method includes: receiving, by a wireless communication terminal, a first release message (S11); and releasing, by the wireless communication terminal, at least one small data transmission, SDT, configuration stored in the wireless communication terminal according to a cell where the first release message is received or according to information of SDT configuration carried by the first release message (S12).

Details in this regard can be ascertained with reference to the paragraphs above, and will not be repeated herein.

Another wireless communication method is also provided according to an embodiment of the present disclosure. In an embodiment, the wireless communication method may be performed by using a wireless communication node (e.g., a gNB). In an embodiment, the wireless communication node may be implemented by using the wireless communication node 50 described above, but is not limited thereto.

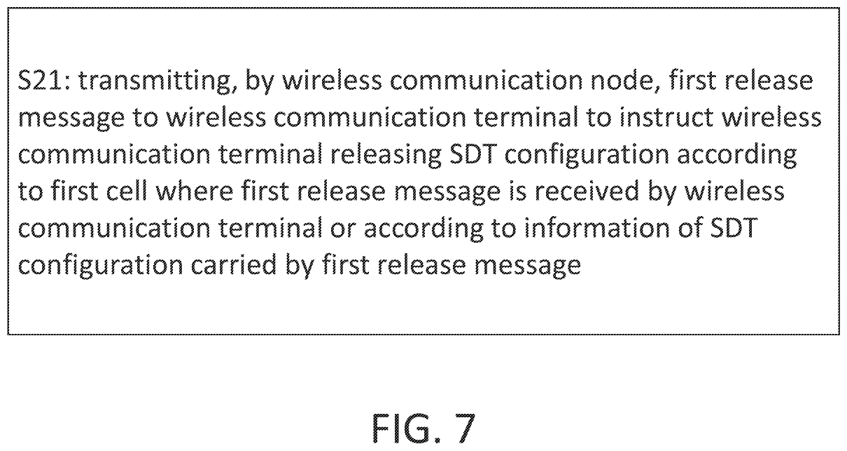

Referring to FIG. 7, in an embodiment, the wireless communication method includes transmitting, by a wireless communication node, a first release message to a wireless communication terminal to instruct the wireless communication terminal releasing at least one small data transmission, SDT, configuration according to a first cell where the first release message is received by the wireless communication terminal or according to information of SDT configuration carried by the first release message (S21).

Details in this regard can be ascertained with reference to the paragraphs above, and will not be repeated herein.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method comprising:
receiving, by a wireless communication terminal, a first release message; and
releasing, by the wireless communication terminal, at least one small data transmission (SDT) configuration stored in the wireless communication terminal according to a cell where the first release message is received or according to information of SDT configuration carried by the first release message.

2. The wireless communication method of claim 1, wherein the at least one SDT configuration is transmitted to the wireless communication terminal via a second release message, and the wireless communication terminal is configured to release all of the at least one SDT configuration stored in the wireless communication terminal in response to the first release message and the second release message are received via different cells.

3. The wireless communication method of claim 1, wherein the wireless communication terminal is configured to release all of the at least one SDT configuration stored in the wireless communication terminal in response to the first release message comprising at least one update SDT configuration.

4. The wireless communication method of claim 1, wherein the wireless communication terminal is configured to store at least one update SDT configuration in response to the first release message comprising the at least one update SDT configuration.

5. The wireless communication method of claim 1, wherein the wireless communication terminal is configured to release all of the at least one SDT configuration stored in the wireless communication terminal in response to the first release message comprising a release indicator.

6. The wireless communication method of claim 1, wherein the first release message comprises a release list, and the wireless communication terminal is configured to release at least a portion of the at least one SDT configuration according to the release list.

7. The wireless communication method of claim 1, wherein the wireless communication terminal is configured to release at least one timer for the at least one SDT configuration according to the first release message, and wherein the first release message is a radio resource control (RRC) release message.

8. The wireless communication method of claim 1, wherein the wireless communication terminal is configured to release the at least one SDT configuration in response to the first release message comprising a release indicator or a release list and not comprising any update SDT configuration.

9. The wireless communication method of claim 1, wherein the at least one SDT configuration is transmitted to the wireless communication terminal via a second release message, the wireless communication terminal is configured to release the at least one SDT configuration in response to the first release message and the second release message being received via different cells and the first release message not comprising a release indicator or a release list and any update SDT configuration.

10. The wireless communication method of claim 1, wherein the at least one SDT configuration is transmitted to the wireless communication terminal via a second release message, the wireless communication terminal is configured to release the at least one SDT configuration in response to the first release message comprising a release indicator or a release list and the first release message and the second release message being received in an identical cell.

11. The wireless communication method of claim 1, wherein the at least one SDT configuration is transmitted to the wireless communication terminal via a second release message, the wireless communication terminal is configured to release the at least one SDT configuration in response to the first release message comprising at least one update SDT configuration, the first release message not comprising any release indicator or any release list, and the first release message and the second release message being received in an identical cell.

12. A wireless communication method comprising:
transmitting, by a wireless communication node, a first release message to a wireless communication terminal to instruct the wireless communication terminal releasing at least one small data transmission (SDT) configuration according to a first cell where the first release message is received by the wireless communication terminal or according to information of SDT configuration carried by the first release message.

13. The wireless communication method of claim 12, wherein the at least one SDT configuration is transmitted to the wireless communication terminal via a second release message in a second cell, and the wireless communication node is configured to transmit the first release message in the first cell different from the second cell to instruct the wireless communication terminal releasing all of the at least one SDT configuration.

14. The wireless communication method of claim 12, wherein the wireless communication node is configured to transmit the first release message comprising at least one update SDT configuration to instruct the wireless communication terminal releasing all of the at least one SDT configuration.

15. The wireless communication method of claim 12, wherein the wireless communication node is configured to transmit the first release message comprising at least one update SDT configuration to instruct the wireless communication terminal storing the at least one update SDT configuration.

16. The wireless communication method of claim 12, wherein the wireless communication node is configured to transmit the first release message comprising a release indicator to instruct the wireless communication terminal releasing all of the at least one SDT configuration.

17. The wireless communication method of claim 12, wherein the wireless communication node is configured to transmit the first release message comprising a release list to instruct the wireless communication terminal releasing at least a portion of the at least one SDT configuration according to the release list.

18. The wireless communication method of claim 12, wherein the wireless communication node is configured to transmit the first release message to instruct the wireless communication terminal releasing at least one timer for the at least one SDT configuration.

19. A wireless communication terminal, comprising:
a communication unit; and
a processor configured to:
receive a first release message; and
release at least one small data transmission (SDT) configuration stored in the wireless communication terminal according to a cell where the first release message is received or according to information of SDT configuration carried by the first release message.

20. A wireless communication node, comprising:
a communication unit; and
a processor configured to transmit a first release message to a wireless communication terminal to instruct the wireless communication terminal releasing at least one small data transmission, SDT, configuration according to a first cell where the first release message is received by the wireless communication terminal or according to information of SDT configuration carried by the first release message.
